(19) United States
(12) Patent Application Publication
(10) Pub. No.: US 2025/0356206 A1
(43) Pub. Date: Nov. 20, 2025

(54) Systems and Methods for Counterfactual Explanations Without Training Datasets

(71) Applicant: ROYAL BANK OF CANADA, Toronto (CA)

(72) Inventors: Kevin H. Wilson, Toronto (CA); Raquel Aoki, Vancouver (CA); Xiangyu Sun, Vancouver (CA)

(21) Appl. No.: 19/013,683

(22) Filed: Jan. 8, 2025

Related U.S. Application Data
(60) Provisional application No. 63/647,978, filed on May 15, 2024.

(51) Int. Cl. G06N 3/092

(52) U.S. Cl. CPC G06N 3/092

(57) ABSTRACT

When ML methods are responsible for making critical decisions, stakeholders often require insights into how to alter these decisions. Counterfactual explanations (CFEs) have emerged as a solution, offering interpretations of opaque ML models and providing a pathway to transition from one decision to another. However, most existing CFE methods require access to a training dataset which was used to train the underlying model and from which an explanation is drawn. Counterfactual explanations can be successfully generated without training dataset through the use of a neural network to determine adjustments to inputs. The neural network can be trained using reinforcement learning techniques.

### RELATED APPLICATIONS

The current application claims priority to U.S. Provisional Patent Application 63/647,978 filed May 15, 2024, entitled “Systems and Methods for Counterfactual Explanations Without Training Datasets,” which is incorporated herein by reference in its entirety for all purposes.

### TECHNICAL FIELD

The current disclosure relates to counterfactual explanations of model predictions, and in particular to counterfactual explanations for time series without training datasets.

### BACKGROUND

Machine learning (ML) methods have experienced significant growth in the past decade, yet their practical application in high-impact real-world domains has been hindered by their opacity. When ML methods are responsible for making critical decisions, stakeholders often require insights into how to alter these decisions. Counterfactual explanations (CFEs) have emerged as a solution, offering interpretations of opaque ML models and providing a pathway to transition from one decision to another. However, most existing CFE methods require access to a training dataset which was used to train the underlying model and from which an explanation is drawn. This requirement can be inaccessible in many scenarios.

Reinforcement learning has been used in counterfactual explanations. CFRL described by Samoilescu et al. in “Model-agnostic and scalable counterfactual explanations via reinforcement learning” of 2021 describes model-agnostic and scalable counterfactual explanations via reinforcement learning (RL) to generate CFEs. CFRL first encodes samples into latent space using autoencoders, then an RL agent is trained to find a CFE in the latent space. Finally, a decoder converts the latent CFE back to the input space.

An additional, alternative and/or improved process for providing counterfactual explanations is desirable.

### BRIEF DESCRIPTION OF THE DRAWINGS

Further features and advantages of the present disclosure will become apparent from the following detailed description, taken in combination with the appended drawings, in which:

FIG. 1 depicts a process for counterfactual explanation without training datasets;

FIG. 2 depicts a method of counterfactual explanation without training datasets;

FIG. 3 depicts details of the counterfactual explanation process;

FIG. 4 depicts a further method of counterfactual explanation without training datasets;

FIG. 5 depicts a system for counterfactual explanation without training datasets; and

FIGS. 6A to 8B depict experiment results for the counterfactual explanation without training datasets process.

### DETAILED DESCRIPTION

In accordance with the present disclosure there is provided a method for use in explaining a predictive model output comprising: receiving an initial model input and a target model output; determining an input adjustment to the initial model input using a trained neural network with parameters θ; adjusting the model input according to the determined input adjustment; calculating a reward for the adjusted model input adjustment according to a reward function; calculating a loss according to a loss function for the trained neural network based on the reward to adjust the parameters θ; applying the adjusted model input to the trained predictive model; determining differences between the adjusted model input and the initial model input if the output of the trained predictive model for the adjusted model input matches the target model output; and outputting the determined difference for use in explaining the predictive model output.

In a further embodiment of the method, the method further comprises: adjusting the parameters θ of the trained neural network using the calculated loss; and determining a second input adjustment using the trained neural network with the adjusted parameters θ.

In a further embodiment of the method, the initial model input comprises a time series.

In a further embodiment of the method, the input adjustment determines a time in the time series to make the adjustment, a feature to adjust and an adjustment to the feature.

In a further embodiment of the method, the feature to adjust is a continuous feature.

In a further embodiment of the method, the feature is a discrete feature.

In a further embodiment of the method, a plurality of subsequent input adjustments are made to the model input.

In a further embodiment of the method, the adjusted model input is applied to the trained predictive model after each subsequent input adjustment.

In a further embodiment of the method, a plurality of adjusted model inputs are determined, each of which when applied to the trained predictive model generate the target model output.

In a further embodiment of the method, one of the plurality of adjusted model inputs is selected as a final adjusted model input.

In a further embodiment of the method, the model input is adjusted according to the input adjustment using a state transfer function.

In a further embodiment of the method, the reward function determines the reward based on: the predictive model; the target output; and a Distance proximity function that provides a distance between an initial model input and adjusted model input.

In a further embodiment of the method, the predictive model is differentiable.

In a further embodiment of the method, the predictive model is not differentiable.

In a further embodiment of the method, the predictive model is a large language model.

In a further embodiment of the method, the input adjustment is made based on user preferences specifying a preference of features to adjust.

In accordance with the present disclosure there is further provided a non-transitory computer readable medium having instructions stored thereon which when executed by a processor configure a system to perform any of the embodiments of the methods described above.

In accordance with the present disclosure there is further provided a system comprising: a processor capable of executing instructions; and a memory storing instructions which when executed by the processor configure the system to perform any of the embodiments of the methods described above.

Machine learning technologies have undergone rapid development over the past few decades, leading to their widespread applications across various real-world domains. However, the adoption of machine learning approaches remains less prevalent in scenarios with high human impacts, such as healthcare and finance. Despite the impressive performance exhibited by certain machine learning models in these domains, they are often opaque in that the internal logic connecting input and output within these models is challenging for humans to reason about. Consequently, stakeholders may have concerns about the reliability of these models in high-impact domains. Moreover, the principle of fairness holds paramount importance in numerous real-world applications. For instance, stakeholders may be obligated to ensure that sensitive attributes (e.g. sex, race, and religion) do not influence decisions made by these machine learning models. However, without a clear understanding of the underlying models, upholding fairness becomes a difficult task. An interest in Explainable AI (XAI) has grown out of these concerns. One approach to explainable AI is the use of counterfactual explanations. Counterfactual explanation (CFE) methods aim to explain predictions by addressing counterfactual “what if” questions. These methods offer not only insights into the decision-making processes of prediction models but also present strategies for altering inputs to yield different target predictions. Current model-agnostic CFE methods for multivariate time-series require access to large collection of samples to the one being explained. This requirement can be infeasible in real-world domains especially due to privacy concerns.

Counterfactual explanations of predictive models can be provided without access to training datasets by applying reinforcement learning techniques in order to determine input adjustments to make in order to generate counterfactual examples. The process described herein, referred to as counterfactual explanation without training datasets (CFWoT), is model-agnostic and suitable for both static and multivariate time-series datasets with continuous and discrete features. Further the CFWoT process provides the flexibility to specify non-actionable, immutable, and preferred features, which further enhances the practicality of the approach. Additionally, the generated counterfactual explanations can be guaranteed to be valid and adhere to user-specified causal constraints.

As described further below, CFWoT provides a reinforcement learning (RL) based CFE method designed for both static and multivariate time-series data containing both continuous and discrete attributes. Remarkably, CFWoT operates without requiring access to a training dataset or similar samples. The CFWoT method is model-agnostic so that it is compatible with any prediction models, even non-differentiable models and large language models (LLMs). CFWoT also allows the user to specify which features they prefer to change, thus allowing them to express what counterfactuals are feasible for them. While CFWoT works for both static and time-series data, the current disclosure focuses on the harder application of multivariate time-series data.

Broadly, the current CFWoT approach uses a neural network with parameters θ to determine actions for adjusting an input in an iterative approach. The adjustments can be used as counterfactual examples when the resulting model output matches a target output. Reinforcement learning techniques can be used to adjust the parameters θ of the neural network used to determine input adjustment actions. In reinforcement learning, an agent and an environment interact with each other. The agent takes an action aₜ on a state sₜ at time step t. The environment receives aₜ and sₜ from the agent and returns the next state sₜ₊₁ and a reward Rₜ₊1 to the agent. The goal of the agent is to maximize the expected cumulative (discounted) reward. RL can be categorized as model-free RL and model-based RL. In model-free RL, the agent learns a policy from real experience when a model of the environment is not available to the agent. In model-based RL, the agent plans a policy from the simulated experience generated from a model of the environment. An RL algorithm can be either model-free or model-based depending on the experience utilized by the agent.

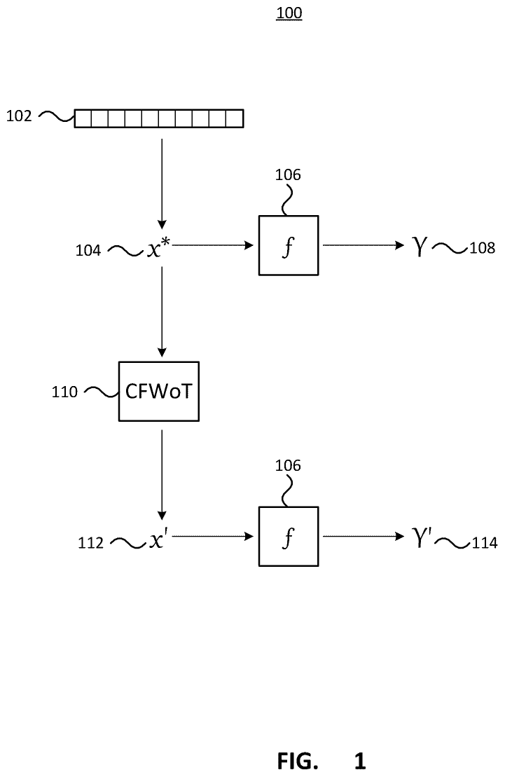

FIG. 1 depicts a process for counterfactual explanation without training datasets. The counterfactual explanation aims to solve a task of: Given the user input sample x*, a prediction model f and a target prediction Y′ such that f (x*)≠Y′, the goal is to find a transformation from x* to a new sample x′. This transformation should satisfy the condition f (x′)=Y′, while ensuring that x′ remains plausible, such as in the same distribution as x*, and maintains a close proximity to x*.

As depicted, a time series 102 can be used as an initial input x* 104. Providing the initial input 104 to a predictive model f 106 generates an output Y 108. Counterfactual explanations may be used to explain why the predictive model 106 provided the output 108. The counterfactual example without training (CFWoT) 110 approach is used to adjust the initial input x* to generate an adjusted input x′ 112. When the adjusted input x′ 112 is applied to the predictive model f 106, an adjusted output Y′ can be generated. By selecting the adjusted output Y′, the resulting adjusted input x′ can be used to explain the model's output Y.

As an example, consider an individual Bob, who applies for a mortgage and receives a rejection from an automated approval model. In such a scenario, two questions may arise: 1) Why was the mortgage application rejected? and 2) How can Bob secure an approval in the future? CFE methods generate “counterfactual samples” similar to, yet not identical to, Bob's initial mortgage application such that the counterfactual mortgage application would be approved by the model. For example, a generated CFE that is identical to Bob's except for a $50,000 increase in income could result in the mortgage being approved. This counterfactual example can answer the two questions, namely it explains the failure of Bob's initial application as being due to insufficient income, and it offers a potential approach for Bob to attain an approval in the future, namely increasing his income by $50,000 a year. In this example, the adjustments to the Bob's initial mortgage application may be considered feasible, that is it is feasible that Bob may make $50,000 in the future. A non-feasible adjustment may be for example, a requirement that Bob increases his salary by more than $1,000,000 per year. While such an adjustment would likely result in the mortgage approval, it may not be considered feasible and as such should not be considered. Further, the adjustments made should also be actionable, that is the adjustment should be able to be made. For example, an adjustment to Bob's birthday is impossible and as such should not be considered since making the adjustment would be impossible in practice.

The CFWoT functionality 110 uses a neural network to determine adjustments to be made to the input, while ensuring resulting adjusted inputs remain feasible, and possibly adjust preferred values of the input. The neural network used for determining the adjustments may be optimized using reinforcement learning techniques.

When adjusting an input to create a CFE input, there may be desirable properties for the CFEs to be effective. The generated CFEs should adhere to the principle of validity, wherein a CFE results in the desired target class being predicted by the prediction model. The modification applied from the original user input to a generated CFE must exclusively pertain to actionable features. Alterations to non-actionable features would lack practical significance. Additionally, a generated CFE should demonstrate proximity to the original user input. This concept is closely related to the notion of feasibility. A CFE is considered closer to the original user input if the change involves a more feasible feature as opposed to a less feasible feature. Feasibility can also encode a user's preference, since each user may prefer to change a different set of features. Moreover, a CFE may be desired to exhibit sparsity, implying a minimal number of modified features. Furthermore, a CFE ought to be plausible, with all features adhering to causal constraints that exist among them. It ensures that the CFE represents an actual state of the world.

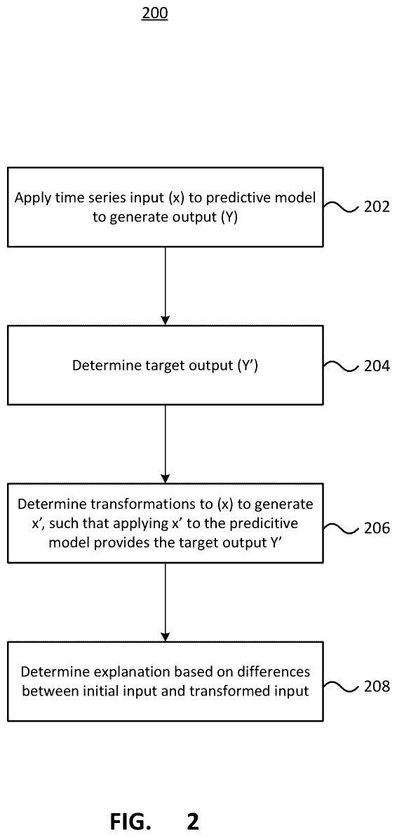

FIG. 2 depicts a method of counterfactual explanation without training datasets. The method 200 begins with a time series input x being applied to a predictive model in order to generate an output Y (202). It is assumed that it is desired to have an explanation as to why the output Y was generated. A target output Y′ is determined (204) that will be able to provide an explanation to the initial output. The target output may be determined as an opposite, or inverse, of the initial output, or as a desired result or outcome. The target output may be automatically determined or may be provided as user input or may be received from other sources. With the initial input and target output, one or more adjustments to the initial input are determined (206) that transform the initial input x to a sample input x′ such that applying the sample input to the predictive model results in the target output Y′. The difference between the initial input x and the sample input x′ can be used to determine an explanation as to why the initial input x generated the initial output Y.

Determining the transformation to the input x may be done using a neural network, along with rules to ensure that feasibility rules for transforming the input are followed. The neural network may be optimized using a reinforcement learning process. Although FIG. 2 describes determining a single transformed input x′, it is possible for the CFWoT process to determine multiple transformed inputs result in the target output.

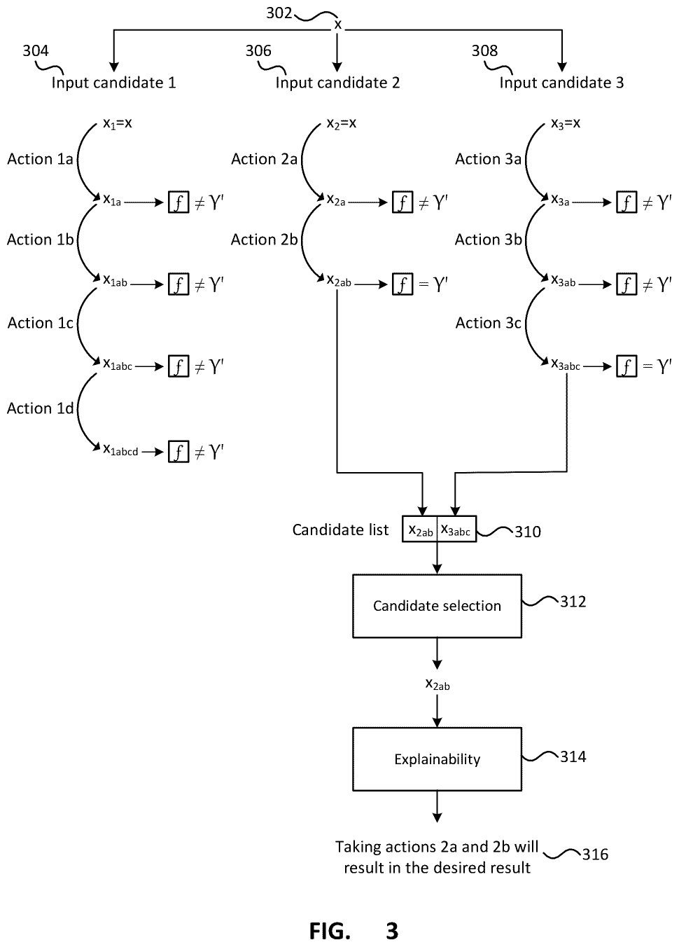

FIG. 3 depicts details of the counterfactual explanation process. As depicted an initial input x 302 is provided which was provided to a prediction model. The input is transformed to one or more input candidates 304, 306, 308. Each of the input candidates are generated in an iterative manner in which an action is determined that adjusts the input. Input adjustments can continue to be made until a stopping condition is reached, such as the adjusted input resulting in the target output, a number of adjustment iterations has been reached, the adjusted input values are not valid or feasible, etc. As depicted in FIG. 3, input candidate 1, 304, is set to the initial input. A first action 1a is determined that adjusts the initial input to an adjusted input x1a. As depicted, when the adjusted input x1a is applied to the predictive model, it does not result in the target output and as such another adjustment action 1b is determined that can be applied to the adjusted input x1a. The further adjusted input x1ab is applied to predictive model which again does not result in the target output. As depicted, this process continues until a stopping condition is reached, which in the case of the first input candidate is depicted as reaching a maximum number of adjustments. The final adjusted input x1 abcd does not result in the target output when applied to the predictive model.

The process is similar for the second and third input candidates 306, 308, however each input is adjusted until it results in the target output. As depicted, the second input candidate is adjusted twice before the output matches the target output. Similarly, the third input candidate is adjusted three times before the output matches the target output. When the adjusted input results in the target output, it can be added to a candidate list 310 of possible counterfactual examples. Candidate selection functionality 312 can select the best input candidates from the list. The selection may be based on various factors, including for example the sparsity of the adjustments, the likelihood of the adjustments, etc. The selected candidate input, depicted as x2ab can be provided to explainability functionality 314. The explainability functionality can provide an explanation of the original output based on differences between the original input and the selected candidate input. The explanation may be provided to explain why the original output was reached, or possibly as an explanation as to how to achieve a desired outcome, such as the target output. As an example, the explanation may indicate that taking actions 2a and 2b will result in the desired result. Similarly, the adjustments 2a and 2b can highlight the features of the original input that were important to the original output since adjusting the values changes the output.

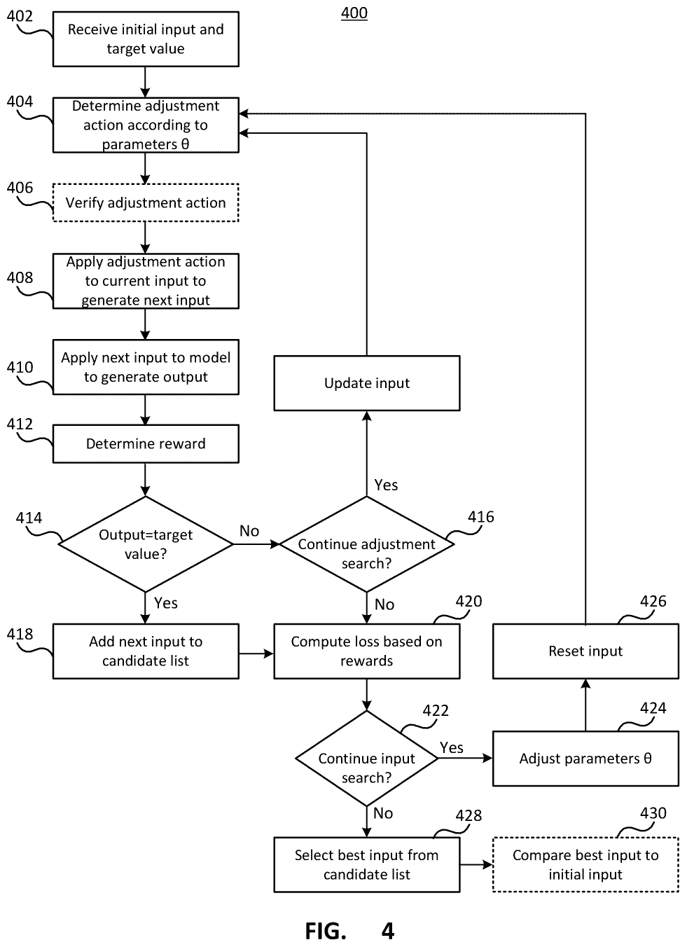

FIG. 4 depicts a further method of counterfactual explanation without training datasets. The method 400 receives an initial input and target output value (402). The initial input may be a time series, or portion of a time series, applied to a predictive model that generated an initial output. It is assumed that it is desired to have the initial output explained. The target output may be provided as an output other than the initial output such that changing the input values no longer result in the initial output, which can provide an indication of which input values were important for causing the initial output and so provide an explanation of the output. Alternatively, the target output may be a desired result and the adjustments to the input can explain what changes can be made to reach the desired input. The CFWoT process is model agnostic and can be applied to a wide range of predictive models, even if the models are not differentiable. The model input may be static, or non-static time series which may be univariate or multivariate and can include continuous and/or discrete features.

An adjustment action is determined using a neural network with parameters θ (404). The action may determine what value(s) to adjust, when in the time series to adjust the value(s) and how to adjust them. The adjustments may be limited to adjusting only those values that are adjustable in practice. The determined adjustment can be verified (406) in order to ensure that the adjustments are sensible, that is the adjustment is feasible. If the determined adjustment is not verified, it can be modified or a different adjustment may be determined. Assuming the adjustment action is verified, it is applied to the current input in order to generate a next input (408). A state transition function may be used to generate the adjusted next input from the current input and the adjustment action. With the next input generated based on the adjustment action, the next input can be applied to the predictive model to generate a corresponding output (410). A reward associated with the adjustment can be determined from a reward function (412). The output is compared to the target output to determine if they match (414). If the output does not match the target output (No at 414) it is determined if further adjustments to the input should be made (416), which may be based on a maximum number of adjustments. If the adjustment search should continue (Yes at 416), the input is updated so that the adjusted next input is used as the current input and further adjustments determined (404). Returning to the comparison of the output to the target output, if the output resulting from the adjusted input matches the target output (Yes at 414) the adjusted next input is added to a candidate list (418). The loss for the neural network the determines the adjustments to the input can be calculated based on the rewards (420) after adding the next input to the candidate list or if the adjustment search should not continue (No at 416). It is determined if the search for further adjusted inputs should continue (422) and if the input search should continue (Yes at 422), the parameters θ of the neural network can be adjusted according to the computed loss (424) and then the current input reset to the initial input (426) in order to search for additional adjusted inputs that would result in the target output. If the input search is completed (No at 422), the best input can be selected from the candidate list. The best input can be selected based on various factors. For example, it may be desirable to select the input candidate that is closest to the initial input meaning it has been adjusted the least. The selected candidate input may be compared to an initial input (430) in order to determine the changes that resulted in the target output, which may be used as an explanation, either for why the initial input caused the initial output, or possibly what changes need to be made to the initial input to arrive aₜ the target output.

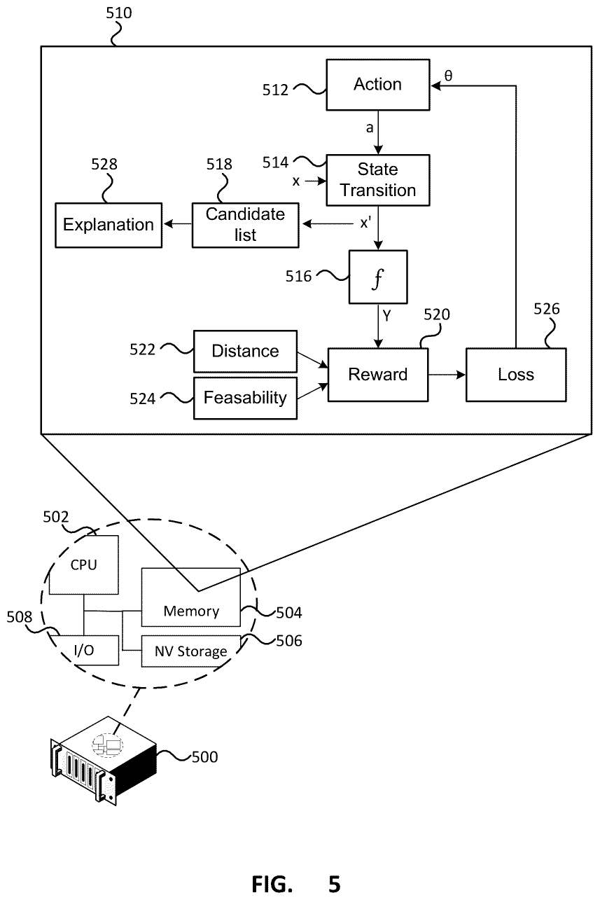

FIG. 5 depicts a system for counterfactual explanation without training datasets. The system is depicted as a single server 500; however, the system may be implemented by one or more computing devices, including for example multiple servers or computing devices communicatively coupled together by one or more networks. The system may be implemented on cloud computing devices that allow compute resources to be effectively scaled as required. Regardless of the particular implementations, the system includes at least one processor 502 that is capable of executing instructions stored in memory 504. The memory 504 may comprise at least one memory unit storing the instructions or portions of the instructions as well as the data, or portions of the data. In addition to the memory 504 which may be volatile, the system may include non-volatile storage 506 for storing instructions and/or data. The system 500 may further include one or more input/output (I/O) interfaces for coupling one or more input and/or output devices to the system, including for example Graphical Processing Units (GPUs) or other dedicated or specialized processing devices. The at least one processor 502 executes instructions in order to configure the system to provide various functionality, including CFWoT functionality 510.

The CFWoT functionality 510 may be used to perform a method such as that described above. The functionality includes action functionality 512 that determines an adjustment action, α, to be made to an input. The action functionality uses a neural network with parameters θ to determine the adjustment action. State transition functionality 514 is provided in order to apply the determined adjustment action α to an input x in order to generate an adjusted input x. A predictive model 516 can be used to generate an output Y from an input. The adjusted input can be added to a candidate list 518 if the output from adjusted input matches a provided target input. Reward functionality 520 may be used to determine a reward associated with an adjustment action. The reward function may use distance functionality 522 and feasibility functionality 524 in determining the reward. The distance functionality may determine a distance between the adjusted input and initial input. Similarly, the feasibility functionality may determine if the adjustment is feasible. Rewards from the reward functionality may be used by loss functionality that can compute a loss for the action neural network, which can adjust the parameters θ of the action network. Explanation functionality 528 can be applied to one or more of the adjusted inputs in the candidate list 518 in order to explain either an initial model output or explain modifications to an input that would result in a desired output.

The CFWoT functionality can be used to automatically determine an explanation of a trained model's output from an input without requiring access to large collection of samples that are to the input being explained. Accordingly, the current CFWoT functionality can improve the functioning of existing computing systems by eliminating the need of large collections of samples for use as counterfactual examples. Further, since the CFWoT functionality does not require the large collection of samples, it can work with a large range of trained models to provide applications in which a counterfactual explanation for an input to the trained model can be automatically provided.

The above has described the counterfactual explanation without training datasets. The following provides an illustrative algorithm that may implement the CFWoT functionality. The algorithm formulates the CFE problem as a reinforcement learning problem.

The prediction model f that predicts an output from a time series input replaces the environment in the reinforcement learning process. A state s may be either the original user input x*, one of the generated CFEs Ot, or anything in-between. An action taken by the agent is one-step of the state transition from x* to Ot. The reward is a combination of the model prediction on a given state and other objectives, such as the feasibility of the adjustment action.

It is assumed that the continuous features of the original input x* are standardized to have mean 0 and variance 1. One-hot encoding for all the categorical features. It is also assumed that the prediction function of f computes fast, which is a common assumption in model-based RL. It will be appreciated that these assumption are not required, but rather simplify the processing.

Pseudocode of the CFWoT process is provided below in Algorithm 1.

### Algorithm 1-CFWoT

Inputs: current user input x*, a prediction model f, a target class Y′, a reward function R, a state transition function Fₚ, a proximity measure Dₚₓₘₜ, a proximity weight λₚₓₘₜ, feature feasibility weights W_{fsib}, maximum number of episodes M_{E}, maximum number of interventions per episode M_{T}, discrete feature indicators Dais, numbers of possible values of discrete features

$${N}_{d i s} = \{ {N}_{d i s}^{d} \vert d ∈ {D}_{d i s} )$$

Further inputs: Non-actionable feature indicators D_{non-act}, immutable feature indicators Dᵢₘₘᵤ, casual constraints C_{scm}, feature range constraints C_{range}, in-distribution detector F_{in-dist}, a discount factor γ, a learning rate α, a regularization weight λ_{WD}

Output: a CFE O*

| | |
|---|---|
| 1 | O = {Ø} |
| 2 | E := 0 |
| 3 | while E < M_{E} do |
| 4 | τ = {Ø} |
| 5 | t := 0 |
| 6 | xₜ = x* |
| 7 | while t < M_{T} do |
| 8 | aₜ~π_{θ}(• \|xₜ) |
| 9 | xₜ₊₁ := Fₚ(xₜ, aₜ) (optionally update xₜ₊₁ according to C_{range}, |
| 10 | C_{scm}, Dᵢₘₘᵤ) |
| 11 | rₜ₊₁ := R(f(xₜ₊₁), Y′, Dₚₓₘₜ(x*, xₜ₊₁, W_{fsib}), λₚₓₘₜ) |
| 12 | τ := τ ∪ (xₜ, aₜ, rₜ₊₁) |
| 13 | if f(xₜ₊₁) = Y′ and xₜ₊₁ ∉ O then |
| 14 | O := O ∪ xₜ₊₁ (optionally if and only if Fᵢₙ_{_{—}}_{dist}(xₜ₊₁) = True) |
| 15 | Break |
| 16 | end if |
| 17 | t := t + 1 |
| 18 | end while |
| 19 | T := t |
| 20 | for t = 0, 1, ... , T − 1 do |
| 21 | G := Σ_{t′=t+1}^{T}γ^{t′-t-1} · r_{t′} |
| 22 | θ = θ + α · γ^{t} · G · ∇lnπ_{θ} (aₜ\|xₜ) |
| 23 | end for |
| 24 | E := E + 1 |
| 25 | end while |
| 26 | 0* := minᵢDₚₓₘₜ(x*, Oᵢ, W_{fsib}) |

In the algorithm, x* ∈ [symbol] ^{K×D} denotes a user input sample, where K and D denote the total number of time steps and features, respectively. To provide for plausibility, the D features can optionally be divided into actionable features which the user can directly change; non-actionable features D_{non-act}, which may be changed due to causal constraints but which the user cannot directly change; and immutable features Dᵢₘₘᵤ which may be used by the predictive model but which cannot change. x* is static if K=1 or temporal if K>1. Tre represents a policy network parameterized by neural networks with parameters θ. Each action α sampled from π_{θ} is 3-dimensional α={a₁, a₂, a₃}, where a₁ denotes that time step of the intervention, a₂ denotes which feature to intervene on, and a₃ corresponds to the strength of the intervention. P·(x) denotes one set of event probabilities in a categorical distribution that are non-negative and sum to 1. θ₁ (x)=P₁ (x) ∈ [symbol] ^{K} and a₁˜Cat (K, θ₁ (1)) denotes which time step of s to intervene on and adjust values. θ₂ (x)=P₂ (x) ∈ [symbol] ^{D-|D}^{_{non-act}}^{|-|D}^{ᵢₘₘᵤₗ} and a₂˜Cat (D−|D_{non-act}|−|Dᵢₘₘᵤ|, θ₂ (1)) denotes which feature of s to intervene on or adjust. For each continuous feature d ⊥D_{non-act} ∪Dᵢₘₘᵤ, that is for each feature d which is not a non-actionable feature (i.e. it is actionable) and is not an immutable feature, θ_{{3,d}}(x)=μ_{{3,d}} (x) ∈ [symbol] and θ_{{4,d}}(x)=σ_{{4,d}}(x) ∈ [symbol] ⁺, which are the mean and standard deviation in a Gaussian distribution N(μ, σ²). Similarly, for each discrete feature d ∉D_{non-act} ∪Dᵢₘₘᵤ,

$${θ}_{\{ 5 , d \}} ( x ) = {P}_{\{ 5 , d \}} ( x ) ∈ {ℛ}^{{N}_{d i s}^{d}} .$$

When a₂ is a continuous feature,

$${a}_{3} ∼ N ( {θ}_{\{ 3 , {a}_{2} \}} ( x ) , {θ}_{\{ 4 , {a}_{2} \}}^{2} ( x ) )$$

and denotes how strong the intervention is for the continuous feature. When a₂ is a discrete feature,

$${a}_{3} ∼ Cat ( {N}_{dis}^{{a}_{2}} , {θ}_{\{ 5 , {a}_{2} \}} ( x ) ) ,$$

which denotes what the interventional value is for the discrete feature.

As a model-agnostic method, CFWoT supports not only classification but also regression prediction models. To work with a regression prediction model, one can replace the “first condition of Line 12 in Algorithm 1 by

$${Y}_{l o w e r}^{′} \leq f ( {x}_{t + 1} ) \leq {Y}_{u p per}^{′} ,$$

where

$${Y}_{l o w e r}^{′} and {y}_{u p p e r}^{′}$$

represent the lower and upper bounds for the target regression value, respectively.

The state transition function Fₚ can be any appropriate function for an application domain. For example Fₚ (xₜ, a={a₁, a₂, a₃}) can be defined as:

$${x}_{t + 1}^{\{ k , d \}} := \{ \begin{matrix}{x}_{t}^{\{ k , d \}} + {a}_{3} & for k \geq {a}_{1} and d = {a}_{2} when feature d is continous \\ {a}_{3} & for k \geq {a}_{1} and d = {a}_{2} when feature d is discrete \\ {x}_{t}^{\{ k , d \}} & otherwise\end{matrix} \qquad ( 1 )$$

Regarding the causal constraints C_{SCM}, many existing techniques require a complete causal graph or a complete structural causal model (SCM) However complete SCMs are often unavailable in practice. CFWoT works with partial SCMs. A partial SCM can be encoded as a set of rules. After the state transition function Fₚ takes place, the new state can be checked to determine if it violates any rules in C_{SCM}. If a rule is violated, CFWoT acts accordingly, for example, it may choose to discard the change or set the corresponding value of the new state that violated a rule to a limiting value.

The reward function R (f (x), Y′, Dₚₓₘₜ (x*, x, W_{fsib}), λₚₓₘₜ) may be defined as

$$r = \{ \begin{matrix}1 - {λ}_{pxmt} \cdot {D}_{pxmt} ( ( {x}^{*} , x , {W}_{fsib} ) & if f ( x ) = {Y}^{′} \\ 0 & otherwise\end{matrix} \qquad ( 2 )$$

The reward function combines a prediction reward, 1 or 0, and a weighted proximity loss Dₚₓₘₜ. Dₚₓₘₜ is 0 when f (x)≠Y′. Otherwise, in difficult settings where f (x)≠Y′ dominates over f (x)=Y′, the RL agent would learn to produce CFEs that are too close to the original user input, which could result in invalid CFEs. λₚₓₘₜ is used to ensure that the reward is positive when f (x)=Y′.

The proximity measure Dₚₓₘₜ can be any suitable measure for the application domain. Dₚₓₘₜ may be defined as the L₁-norm for continuous features and L₀-norm for discrete features, weighted by W_{fsib}. Dₚₓₘₜ may be defined as:

$${D}_{pxmt} ( {x}^{d} , {x}^{′ d} , {W}_{fsib} ) = \{ \begin{matrix}{\sum }_{k = 1}^{K} \vert {x}^{\{ k , d \}} - {x}^{′ \{ k , d \}} \vert \cdot {W}_{fsib} & if feature d is continuous \\ {\sum }_{k = 1}^{K} I ( {x}^{\{ k , d \}} \neq {x}^{′ \{ k , d \}} ) \cdot {W}_{fsib} & if feature d is discrete\end{matrix} \qquad ( 3 )$$

W_{fsib}^{d} denotes the feasibility to change the d^{th} feature, which encodes the user's preference on altering this feature. CFWoT prefers to generate CFEs by altering features associated with small W_{fsib}. If a user does not specify preferences on altering features, 1 for W_{fsib} may be assumed.

The above CFWoT process was evaluated. Qualitative examples and quantitative experiment results, described further below, demonstrate the effectiveness of the described process for multivariate time-series data. Three real-world multivariate time time-series datasets are used for evaluation: Life Expectancy, NATOPS and Heartbeat.

The qualitative examples were generated by CFWoT with two interpretable rule-based prediction models and an interpretable Life Expectancy dataset. The qualitative examples were generated using the first sample of the Life Expectancy dataset, which represents the country Albania.

The Life Expectancy dataset has 119 samples. Each sample has 16 time steps (from 2000 to 2015) and 17 features per time step. All the features are interpretable. The feature of the Life Expectancy dataset are set forth in Table 1 below. The features “Country Name” and “Year” were removed from the list of input features and use “Life Expectancy” in 2015 as the label. Therefore, the dataset has K=16 and D=14 in the notation used herein. Y=1 if “Life Expectancy” in 2015 is greater or equal to 75 as the target class and otherwise Y=0 as the undesired class.

TABLE 1
Table of Life Expectancy dataset features

| Features | Type |
|---|---|
| Country Name | Categorical |
| Year | Categorical |
| Continent | Categorical |
| Least Developed | Categorical |
| Population | Continuous |
| CO2 Emissions | Continuous |
| Health Expenditure | Continuous |
| Electric Power Consumption | Continuous |
| Forest Area | Continuous |
| GDP per Capita | Continuous |
| Individuals Using the Internet | Continuous |
| Military Expenditure | Continuous |
| People Practicing Open Defecation | Continuous |
| People Using at Least Basic Drinking Water | Continuous |
| Services | |
| Obesity Among Adults | Continuous |
| Beer Consumption per Capita | Continuous |
| Label: Life Expectancy | Categorical |

Two interpretable rule based prediction models for the Life Expectancy dataset were employed. d₁, d₂, d₃, d₄, d₅ denote the features “least-developed,” “GDP-per-capita,” “health-expenditure,” “people-using-a-least-basic-drinking-water-services,” and “people-practicing-open-defecation,” respectively. The first rules based model may be defined as:

$$f ( x ) = \{ \begin{matrix}{Y}^{′} & \begin{matrix}if {x}^{\{ k , {d}_{1} \}} = 0 ⋀ {x}^{\{ k , {d}_{2} \}} > 0 ⋀ {x}^{\{ k , {d}_{3} \}} > \\ 0 ⋀ {x}^{\{ k , {d}_{4} \}} > 0 ⋀ {x}^{\{ k , {d}_{5} \}} < 0 for K - 4 \leq k \leq K\end{matrix} \\ Y & otherwise\end{matrix}$$

The second rules based model may be defined as:

$$f ( x ) = \{ \begin{matrix}{Y}^{′} & \begin{matrix}if {x}^{\{ k , {d}_{1} \}} = 0 ⋀ ( {x}^{\{ k , {d}_{2} \}} > 0 ⋁ {x}^{\{ k , {d}_{3} \}} > 0 ) ⋀ {x}^{\{ k , {d}_{4} \}} > \\ 0 ⋀ {x}^{\{ k , {d}_{5} \}} < 0 for K - 4 \leq k \leq K\end{matrix} \\ Y & otherwise\end{matrix}$$

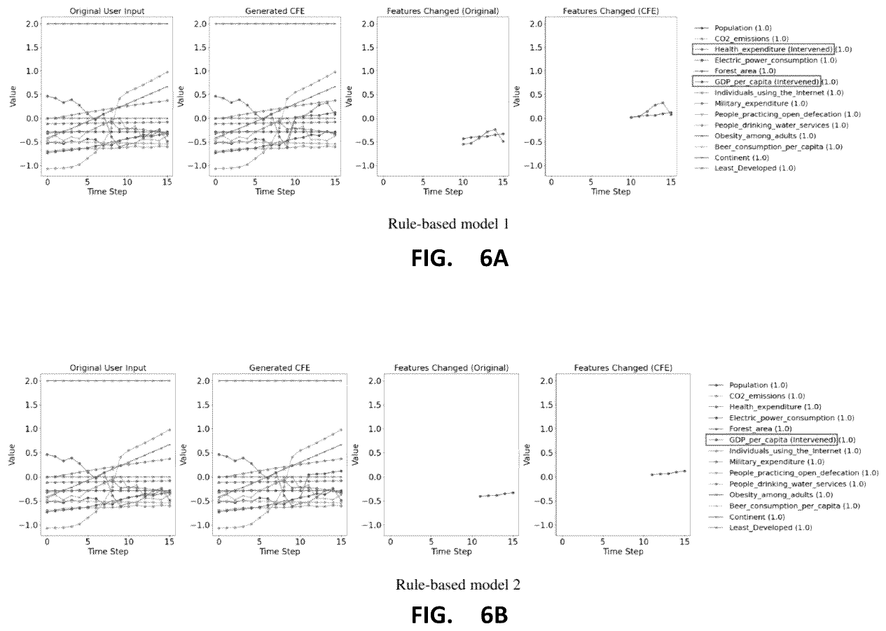

In FIGS. 6A, 6B, all features have equal feasibility weights (W_{fsib}=1.0) as no user preferences are set. In FIG. 6A, following the definition of rule-based model 1 for the life expectancy dataset, Albania's prediction is 0 because “GDP-per-capita” and “health-expenditure” in the last 5 years are below 0. Accordingly, CFWoT generates a CFE by increasing these values above 0. In FIG. 6B, if at least one of “GDP-per-capita” or “health-expenditure” is above 0 in the last 5 years, then rule-based model 2 predicts 1. CFWoT generates a valid CFE for rule-based model 2 by raising “GDP-per-capita” above 0.

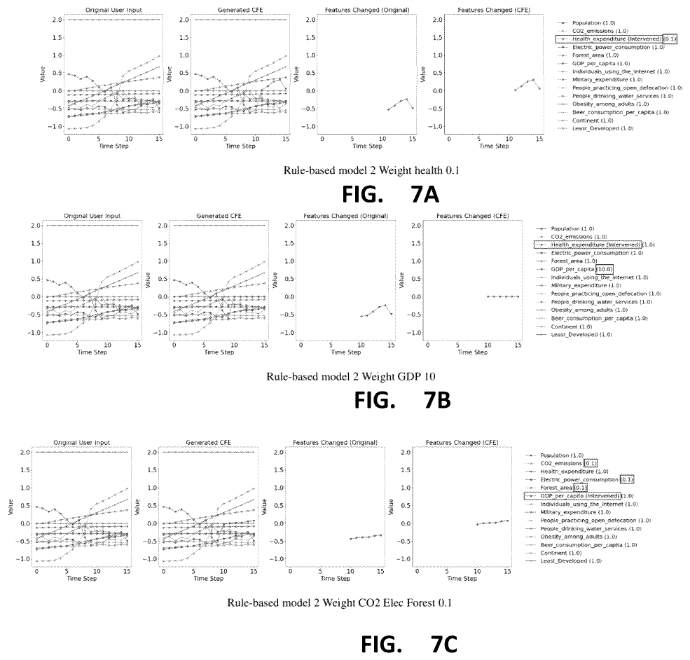

However, changing “GDP-per-capita” for Albania may be impractical. An alternative way to make rule-based model 2 predict 1 is to increase “health-expenditure” above 0. CFWoT can achieve this in three different ways: (1) marking “GDP-per-capita” as non-actionable; (2) assigning a small feasibility weight to “health-expenditure;” or (3) assigning a large feasibility weight to “GDP-per-capita.” (1) is straightforward. Hence, only the results for (2) and (3) are presented. In FIG. 7a, the feasibility weight W_{fsib} for “health-expenditure” is set to 0.1, ten times smaller than that of “GDP-per-capita,” which remains unchanged as 1. With the reduced feasibility weight for “health-expenditure,” CFWoT generates a valid CFE by modifying “health-expenditure’ In FIG. 7b, the feasibility weight for “GDP-per-capita” is set to 10, ten times greater than other features. With the high feasibility weight for “GDP-per-capita,” CFWoT preserves “GDP-per-capita” and looks for other features to achieve the desired prediction. As a result, CFWoT learns to alter “health-expenditure”.

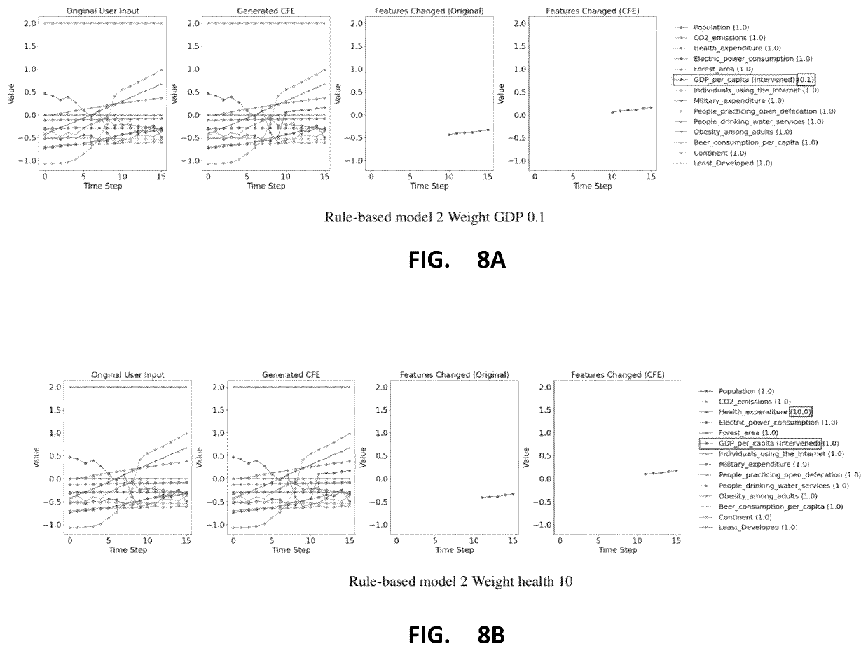

Next, it is shown that setting small feasibility weights on irrelevant features does not affect the CFEs generated by CF-WoT. In FIG. 7c, the feasibility weights for some of the irrelevant features (e.g. “CO2-emissions,” “electric-power-consumption,” and “forest-area”) are set to be ten times smaller than others. CFWoT still alters “GDP-per-capita” as in FIG. 6b. Additional results for different feasibility weights are provided in FIG. 8a, 8b.

In addition to the qualitative examples of the Life Expectancy dataset, CFWoT was compared to 4 baseline methods in 40 experiments, which correspond to 8 real-world datasets each evaluated with 5 prediction models. Eight real-world multivariate time-series datasets are used for evaluation: Life Expectancy, NATOPS, Heartbeat, Racket Sports, Basic Motions, eRing, Japanese Vowels, and Libras. The Life Expectancy dataset was described above, and the other datasets used described below.

The NATOPS dataset contains sensory data on hands, elbows, wrists and thumbs to classify movement types. It has 180 samples. Each sample has 51 time steps and 24 features per time step, i.e. K=51 and D=24. All the features in this dataset are continuous. There are 6 classes of different movements. The target classes were set as classes 4 to 6.

The Heartbeat dataset has 204 samples. Each sample has 405 time steps and 61 features per time step, i.e. K=405 and D=61. All the features in this dataset are continuous. There are two classes: normal heartbeat, which is used as the target class, and abnormal heartbeat, which is used as the undesired class.

The Racket Sports dataset has 151 samples. Each sample has 30 time steps and 6 features per time step, i.e. K=30 and D=6. All the features in this dataset are continuous. There are four classes: “Badminton Smash”, “Badminton Clear”, “Squash Forehand Boast” and “Squash Backhand Boast”. The last two classes were used as the target classes.

The Basic Motions dataset has 40 samples. Each sample has 100 time steps and 6 features per time step, i.e. K=100 and D=6. All the features in this dataset are continuous. There are four classes: “Badminton”, “Running”, “Standing” and “Walking”. The “Standing” clas was used as the target class.

The eRing dataset has 30 samples. Each sample has 65 time steps and 4 features per time step, i.e. K=65 and D=4. All the features in this dataset are continuous. There are six classes and the last three classes were used as the target classes.

The Japanese Vowels dataset has 270 samples. Each sample has 29 time steps and 12 features per time step, i.e. K=29 and D=12. All the features in this dataset are continuous. There are nine classes and the last five classes were used as the target classes.

The Libras dataset has 180 samples. Each sample has 45 time steps and 2 features per time step, i.e. K=45 and D=2. All the features in this dataset are continuous. There are 15 classes and the last eight classes were used as the target classes.

All the categorical features are one-hot encoded. All the continuous features are standardized to have mean 0 and variance 1.

The CFWoT process was benchmarked against four model-agnostic baseline methods: COMTE, Native-Guide, CFRL, and FastAR. Optimization-based methods were excluded from the comparison, because the prediction models that can be used with CFWoT are not restricted to differentiable models. For Native-Guide, multivariate time-series samples were concatenated into univariate time-series samples.

In the quantitative benchmarking, CFWoT was used with five different prediction models for each of the datasets. The prediction models were a long short-term memory (LSTM) neural network, a K-nearest neighbor (KNN), a random forest, and two interpretable rule-based models.

For LSTM, the first layer of the neural network is a LSTM layer with 30 hidden states, followed by two linear layers. The first linear layer takes input of dimension of 30 and produces an output of dimension 60, then passes the output to a ReLU activation function. The second linear layer takes input of dimension of 60 and produces an output, then passes the output to a sigmoid activation function. The LSTM was trained with learning rate 0.001 and weight decay 0.001 for 5000 epochs.

For KNN, the number of neighbors to use for prediction is \sqrt{N}, where N denotes the number of samples in the dataset.

For random forest the number of trees is 100. The minimum number of samples required to split an internal node is 2. The minimum number of samples required to be aₜ a leaf node is 1.

The interpretable rule-based models for the different datasets are described below, in which Y′ is the desired class and Y is the undesired class.

For quantitative experiments with the NATOPS dataset, d₁, d₂ denote the features “Hand tip left, X coordinate” and “Hand tip right, X coordinate” respectively. The first rule based model for the NATOPS dataset was defined as:

$$f ( x ) = \{ \begin{matrix}{Y}^{′} & if {x}^{\{ k , {d}_{1} \}} > 0 ⋀ {x}^{\{ k , {d}_{2} \}} > 0 for K - 9 \leq k \leq K \\ Y & otherwise\end{matrix}$$

The second rules based model for NATOPS dataset was defined as:

$$f ( x ) = \{ \begin{matrix}{Y}^{′} & if {x}^{\{ k , {d}_{1} \}} > 0 ⋁ {x}^{\{ k , {d}_{2} \}} > 0 for K - 9 \leq k \leq K \\ Y & otherwise\end{matrix}$$

For quantitative experiments with the Heartbeat dataset, d₁, d₂, d₃ denote the features “feature_1”, “feature_2” and “feature_3” respectively. The first rules based for the Heartbeat dataset model was defined as:

$$f ( x ) = \{ \begin{matrix}{Y}^{′} & if {x}^{\{ k , {d}_{1} \}} > 0 ⋀ {x}^{\{ k , {d}_{2} \}} > 0 ⋀ {x}^{\{ k , {d}_{3} \}} > 0 for K - 4 \leq k \leq K \\ Y & otherwise\end{matrix}$$

The second rules based model for the Heartbeat dataset was defined as:

$$f ( x ) = \{ \begin{matrix}{Y}^{′} & if {x}^{\{ k , {d}_{1} \}} > 0 ⋁ {x}^{\{ k , {d}_{2} \}} > 0 ⋁ {x}^{\{ k , {d}_{3} \}} > 0 for K - 4 \leq k \leq K \\ Y & otherwise\end{matrix}$$

For quantitative experiments with the Racket Sports dataset, dᵢ denote i^{th}. The first rules based for the Racket Sports dataset model was defined as:

$$f ( x ) = \{ \begin{matrix}{Y}^{′} & if {x}^{\{ k , {d}_{1} \}} > 0 ⋀ {x}^{\{ k , {d}_{5} \}} > 0 for K - 4 \leq k \leq K \\ Y & otherwise\end{matrix}$$

The second rules based model for the Racket Sports dataset was defined as:

$$f ( x ) = \{ \begin{matrix}{Y}^{′} & if {x}^{\{ k , {d}_{1} \}} > 0 ⋁ {x}^{\{ k , {d}_{5} \}} > 00 for K - 4 \leq k \leq K \\ Y & otherwise\end{matrix}$$

For quantitative experiments with the Basic Motions dataset, dᵢ denote i^{th}. The first rules based for the Basic Motions dataset model was defined as:

$$f ( x ) = \{ \begin{matrix}{Y}^{′} & if {x}^{\{ k , {d}_{1} \}} > 0 ⋀ {x}^{\{ k , {d}_{3} \}} > 0 ⋀ {x}^{\{ k , {d}_{6} \}} > 0 for K - 9 \leq k \leq K \\ Y & otherwise\end{matrix}$$

The second rules based model for the Basic Motions dataset was defined as:

$$f ( x ) = \{ \begin{matrix}{Y}^{′} & if {x}^{\{ k , {d}_{1} \}} > 0 ⋁ {x}^{\{ k , {d}_{3} \}} > 0 ⋁ {x}^{\{ k , {d}_{6} \}} > 0 for K - 4 \leq k \leq K \\ Y & otherwise\end{matrix}$$

For quantitative experiments with the eRing dataset, dᵢ denote i^{th}. The first rules based for the eRing dataset model was defined as:

$$f ( x ) = \{ \begin{matrix}{Y}^{′} & if {x}^{\{ k , {d}_{2} \}} > 0 ⋀ {x}^{\{ k , {d}_{3} \}} > 0 for K - 9 \leq k \leq K \\ Y & otherwise\end{matrix}$$

The second rules based model for the eRing dataset was defined as:

$$f ( x ) = \{ \begin{matrix}{Y}^{′} & if {x}^{\{ k , {d}_{2} \}} > 0 ⋁ {x}^{\{ k , {d}_{3} \}} > 0 for K - 4 \leq k \leq K \\ Y & otherwise\end{matrix}$$

For quantitative experiments with the Japanese Vowels dataset, dᵢ denote i^{th}. The first rules based for the Japanese Vowels dataset model was defined as:

$$f ( x ) = \{ \begin{matrix}{Y}^{′} & if {x}^{\{ k , {d}_{1} \}} > 0 ⋀ {x}^{\{ k , {d}_{6} \}} > 0 ⋀ {x}^{\{ k , {d}_{12} \}} > 0 for K - 19 \leq k \leq K \\ Y & otherwise\end{matrix}$$

The second rules based model for the Japanese Vowels dataset was defined as:

$$f ( x ) = \{ \begin{matrix}{Y}^{′} & if {x}^{\{ k , {d}_{1} \}} > 0 ⋁ {x}^{\{ k , {d}_{6} \}} > 0 ⋁ {x}^{\{ k , {d}_{12} \}} > 0 for K - 4 \leq k \leq K \\ Y & otherwise\end{matrix}$$

For quantitative experiments with the Libras dataset, dᵢ denote i^{th}. The first rules based for the Libras dataset model was defined as:

$$f ( x ) = \{ \begin{matrix}{Y}^{′} & if {x}^{\{ k , {d}_{1} \}} > 0 ⋀ {x}^{\{ k , {d}_{2} \}} > 0 for K - 19 \leq k \leq K \\ Y & otherwise\end{matrix}$$

The second rules based model for the Libras dataset was defined as:

$$( x ) = \{ \begin{matrix}{Y}^{′} & if {x}^{\{ k , {d}_{1} \}} > 0 ⋁ {x}^{\{ k , {d}_{2} \}} > 0 for K - 4 \leq k \leq K \\ Y & otherwise\end{matrix}$$

The quantitative evaluations used five metrics. Nᵢₙᵥ denotes the total number of invalid samples, i.e., those classified as the undesired class by a prediction model in the testing dataset, N_{inv_val} denote the number of invalid samples for which a CFE method generates valid CFEs, Nᵥₐₗ denote the number of valid CFEs generated by a CFE method, N_{CFE} denote the number of CFEs generated by a CFE method, Nplau val denote the number of plausible and valid CFEs generated by a CFE method. Feature feasibility weights

$${W}_{fsib}^{= d} = 1$$

for all features d ∈D.

The benchmarking considered success rate, validity rate, plausibility rate and proximity and sparsity.

Success rate is define as

$$\frac{{N}_{inv \_ val}}{{N}_{inv}} .$$

There are two scenarios for a CFE method to fail: 1) no valid CFEs are generated; 2) no CFEs (either valid or invalid) are generated. For RL-based baselines, CFRL and FastAR fail with a 0% success rate in 28/40 and 34/40 cases, respectively. CFWoT outperforms CFRL in 29/40 cases, and is on par with CFRL in 10/40 cases. In contrast, CFRL outperforms CFWoT in 1/40 case. CFWoT outperforms FastAR in all 40/40 cases. For Native-Guide, CoMTA and CFWoT fail with a 0% success rate in 0/40, 3/40 and 0/40 cases, respectively. CFWoT outperforms Native-Guide in 8/40 cases, and is on par with Native-Guide in 25/40 cases. Native-Guide outperforms CFWoT in 7/40 cases. However, the minimum success rate that Native-Guide gives is 30.855%, which is better than that of CFWoT (0.68%). COMTE outperforms CFWoT in success rate. COMTE achieves higher success rates than CFWoT in 11/40 cases, and achieves the same success rates as CFWoT in 26/40 cases. In contrast, CFWoT outperforms COMTE in only 3/40 cases.

It is important to note that: 1) Training datasets are provided to the baselines as they require training datasets to operate), but not to CFWoT. This additional information provided only to the baselines gives them an advantage over CFWoT. Without training datasets, the methods stop working except CFWoT. 2) The success rate of CFWoT can be further improved, e.g. from 0.68% to 76.87% by adjusting M_{E}.and/or M_{T}.

Validity Rate is defined as

$${\frac{{N}_{val}}{{N}_{CFE}} .}^{}$$

Both CFWoT and CoMTE ensure perfect validity rates by design; they either produce a valid CFE or do not produce a CFE at all. In contrast, the other three baselines may return invalid CFEs; therefore, their validity rates may not be perfect. Furthermore, there are 3 cases where COMTE fails completely with a 0% success rate. This results in undefined validity rates for COMTE because N_{CFE}=0. Hence, CFWoT outperforms all baselines in the experiments in terms of validity rate (i.e., 100% for all 40 cases). However, if there were cases where CFWoT fail with a 0% success rate, the validity rate for CFWoT would also be undefined.

Plausibility Rate is defined as

$$\frac{{N}_{plau \_ val}}{{N}_{val}} .$$

The comparisons to CFRL and FastAR are skipped because more than half of the experiments yield 0% success rates, and therefore, undefined plausibility rates. CFWoT outperforms and is on par with Native-Guide in 14/24 and 1/24 cases, respectively. Native-Guide outperforms CFWoT in 9/24 cases. COMTE is on par with CFWoT in 8/26 cases and outperforms CFWoT in 18/26 cases. In summary, in terms of plausibility rate, COMTE outperforms CFWoT, and CFWoT outperforms Native-Guide. Again, the baselines have the advantage by utilizing additional training information that is not provided to CFWoT.

Additionally, one can enforce plausibility in CFWoT (Line 17 of Algorithm 1). CFWoT achieves 100% plausibility rates at the cost of lower success rates and higher proximity and sparsity, as described below with reference to CFWoT_{in_dist}.

Proximity and Sparsity Proximity is defined as an unweighted equation for Dₚₓₘₜ as in equation (3) above. Sparsity is defined as the (unweighted) Lo-norm of the difference between the CFE and the original x* for both continuous and discrete features, which is equivalent to an unweighted version of the second equation of Equation (3). Due to the aforementioned reason, proximity and sparsity are computed only with valid CFEs. Therefore, comparison with FastAR is skipped. CFWoT outperforms all the baselines in proximity and sparsity: CFWoT outperforms CFRL in all 10 cases, Native-Guide in all 24 cases, and COMTE in all 25 cases. CFWoT surpasses the baselines by a large margin in proximity and sparsity. For example, there are 3, 7 or 14 cases where the proximity of CFWoT is at least 20 times, 10 times or 5 times smaller than that of all the baselines, respectively (e.g., 16.183 vs. 220.552). Similarly, there are 2, 4 or 20 cases where the sparsity of CFWoT is at least 50 times, 20 times or 10 times smaller than that of all the baselines, respectively (e.g., 20.587 vs. 1224.0).

The results of the benchmarks are set out in Tables 2-17 below. CFWoT outperforms the two RL-based methods, CFRL and FastAR, in all the metrics. CFRL and FastAR often fail to generate valid CFEs for complex multivariate time-series data. Although COMTE surpasses CFWoT in 8 out of 15 cases in success rate and 13 out of 15 cases in plausibility rate, it's important to highlight that COMTE requires a training dataset, while CFWoT does not. COMTE's better performance over CFWoT comes aₜ the cost of needing more information and reduced versatility in practical applications. Additionally, COMTE relies on finding distractors correctly classified as the target class. In scenarios when there lacks samples with target class labels or when the prediction models classify all training samples as the undesired class, COMTE can fail completely with a 0% success rate, as shown in the result. In contrast, CFWoT is more versatile and can operate in such difficult situations. Furthermore, in Table 17, it is shown that the success rates of CFWoT can be improved by increasing the maximum number of episodes M_{E} or the maximum number of interventions per episode M_{T}.

TABLE 2
Quantitative results with eRing dataset

| Predictive | | | Success | Validity | Plausibility | | |
|---|---|---|---|---|---|---|---|
| Model | Nᵢₙᵥ | Methods | Rate | Rate | Rate | Proximity | Sparsity |
| LSTM | 14 | CoMTE | 100.0% | 100.0% | 100.0% | 346.746 | 260.0 |
| | | Native-Guide | 100.0% | 100.0% | 100.0% | 316.502 | 260.0 |
| | | CFRL | 0.0% | 0.0% | — | — | — |
| | | FastAR | 0.0% | 0.0% | — | — | — |
| | | CFWoT | 100.0% | 100.0% | 100.0% | 54.682 | 31.214 |
| KNN | 16 | CoMTE | 100.0% | 100.0% | 100.0% | 338.141 | 260.0 |
| | | Native-Guide | 100.0% | 100.0% | 93.75% | 1.3e12 | 229.938 |
| | | CFRL | 100.0% | 100.0% | 100.0% | 321.046 | 260.0 |
| | | FastAR | 0.0% | 0.0% | — | — | — |
| | | CFWoT | 100.0% | 100.0% | 100.0% | 144.937 | 86.688 |
| RF | 15 | CoMTE | 100.0% | 100.0% | 100.0% | 340.338 | 260.0 |
| | | Native-Guide | 100.0% | 100.0% | 93.333% | 3.2e12 | 246.467 |
| | | CFRL | 0.0% | 0.0% | — | — | — |
| | | FastAR | 0.0% | 0.0% | — | — | — |
| | | CFWoT | 100.0% | 100.0% | 100.0% | 68.882 | 46.733 |
| RB 1 | 29 | CoMTE | 0.0% | — | — | — | — |
| | | Native-Guide | 100.0% | 100.0% | 44.828% | 9.9e14 | 256.552 |
| | | CFRL | 0.0% | 0.0% | — | — | — |
| | | FastAR | 0.0% | 0.0% | — | — | — |
| | | CFWoT | 100.0% | 100.0% | 100.0% | 103.953 | 63.345 |
| RB 2 | 25 | CoMTE | 100.0% | 100.0% | 100.0% | 347.295 | 260.0 |
| | | Native-Guide | 100.0% | 100.0% | 88.0% | 5.0e13 | 245.4 |
| | | CFRL | 0.0% | 0.0% | — | — | — |
| | | FastAR | 0.0% | 0.0% | — | — | — |
| | | CFWoT | 100.0% | 100.0% | 100.0% | 31.301 | 14.76 |

TABLE 3a
Quantitative results with Libras dataset.
Prediction model KNN. Nᵢₙᵥ = 89

| | Success | Validity | Plausibility | | |
|---|---|---|---|---|---|
| Methods | Rate | Rate | Rate | Proximity | Sparsity |
| CoMTE | 100.0% | 100.0% | 100.0% | 118.379 | 88.989 |
| Native- | 100.0% | 100.0% | 51.685% | 126.318 | 89.213 |
| Guide | | | | | |
| CFRL | 100.0% | 100.0% | 100.0% | 139.54 | 90.0 |
| FastAR | 1.124% | 1.124% | 0.0% | 4.4 | 3.0 |
| CFWoT | 100.0% | 100.0% | 14.607% | 45.306 | 24.112 |

TABLE 3b
Quantitative results with Libras dataset.
Prediction model Random forest. Nᵢₙᵥ = 84

| | Success | Validity | Plausibility | | |
|---|---|---|---|---|---|
| Methods | Rate | Rate | Rate | Proximity | Sparsity |
| CoMTE | 100.0% | 100.0% | 100.0% | 108.074 | 88.393 |
| Native-Guide | 100.0% | 100.0% | 75.0% | 111.086 | 87.143 |
| CFRL | 0.0% | 0.0% | — | — | — |
| FastAR | 0.0% | 0.0% | — | — | — |
| CFWoT | 100.0% | 100.0% | 13.095% | 50.151 | 27.024 |

TABLE 3c
Quantitative results with Libras dataset.
Prediction model Rule-Based 1. Nᵢₙᵥ = 116

| | Success | Validity | Plausibility | | |
|---|---|---|---|---|---|
| Methods | Rate | Rate | Rate | Proximity | Sparsity |
| CoMTE | 100.0% | 100.0% | 100.0% | 144.053 | 88.836 |
| Native-Guide | 100.0% | 100.0% | 87.069% | 135.861 | 88.836 |
| CFRL | 0.0% | 0.0% | — | — | — |
| FastAR | 0.0% | 0.0% | — | — | — |
| CFWoT | 100.0% | 100.0% | 6.034% | 74.67 | 39.647 |

TABLE 3d
Quantitative results with Libras dataset.
Prediction model Rule-Based 2. Nᵢₙᵥ = 53

| | Success | Validity | Plausibility | | |
|---|---|---|---|---|---|
| Methods | Rate | Rate | Rate | Proximity | Sparsity |
| CoMTE | 100.0% | 100.0% | 100.0% | 131.461 | 90.0 |
| Native-Guide | 100.0% | 100.0% | 98.113% | 135.119 | 90.0 |
| CFRL | 0.0% | 0.0% | — | — | — |
| FastAR | 0.0% | 0.0% | — | — | — |
| CFWoT | 100.0% | 100.0% | 20.755% | 45.037 | 23.962 |

TABLE 4
Quantitative results with Life Expectancy dataset

| Predictive | | | Success | Validity | Plausibility | | |
|---|---|---|---|---|---|---|---|
| Model | Nᵢₙᵥ | Methods | Rate | Rate | Rate | Proximity | Sparsity |
| LSTM | | CoMTE | 100.0% | 100.0% | 100.0% | 37.475 | 201.54 |
| | | Native-Guide | 100.0% | 100.0% | 85.714% | 30.674 | 190.238 |
| | 63 | CFRL | 0.0% | 0.0% | — | — | — |
| | | FastAR | 1.587% | 1.587% | 100.0% | 0.45 | 1.0 |
| | | CFWoT | 98.413% | 100.0% | 80.645% | 10.893 | 64.065 |
| KNN | 68 | CoMTE | 100.0% | 100.0% | 100.0% | 46.366 | 204.176 |
| | | Native-Guide | 100.0% | 100.0% | 48.529% | 1451883310426.289 | 200.574 |
| | | CFRL | 100.0% | 100.0% | 100.0% | 44.264 | 206.824 |
| | | FastAR | 0.0% | 0.0% | — | — | — |
| | | CFWoT | 85.294% | 100.0% | 58.621% | 19.756 | 82.879 |
| RF | 62 | CoMTE | 100.0% | 100.0% | 100.0% | 33.752 | 199.468 |
| | | Native-Guide | 100.0% | 100.0% | 79.032% | 28343717711504.21 | 200.548 |
| | | CFRL | 100.0% | 100.0% | 100.0% | 44.684 | 207.484 |
| | | FastAR | 0.0% | 0.0% | — | — | — |
| | | CFWoT | 100.0% | 100.0% | 96.774% | 8.724 | 49.661 |
| RB 1 | 87 | CoMTE | 100.0% | 100.0% | 100.0% | 47.542 | 203.747 |
| | | Native-Guide | 65.517% | 65.517% | 66.667% | 85800668810944.44 | 193.526 |
| | | CFRL | 0.0% | 0.0% | — | — | — |
| | | FastAR | 0.0% | 0.0% | — | — | — |
| | | CFWoT | 82.759% | 100.0% | 88.889% | 10.566 | 49.25 |
| RB 2 | 55 | CoMTE | 100.0% | 100.0% | 100.0% | 47.108 | 203.327 |
| | | Native-Guide | 72.727% | 72.727% | 60.0% | 77494497574951.52 | 183.025 |
| | | CFRL | 0.0% | 0.0% | — | — | — |
| | | FastAR | 0.0% | 0.0% | — | — | — |
| | | CFWoT | 81.818% | 100.0% | 86.667% | 11.238 | 52.667 |

TABLE 5
Quantitative results with NATOPS dataset

| Predictive | | | Success | Validity | Plausibility | | |
|---|---|---|---|---|---|---|---|
| Model | Nᵢₙᵥ | Methods | Rate | Rate | Rate | Proximity | Sparsity |
| LSTM | 90 | CoMTE | 100.0% | 100.0% | 100.0% | 1285.262 | 1224.0 |
| | | Native-Guide | 100.0% | 100.0% | 63.333% | 12699535493460.361 | 1158.133 |
| | | CFRL | 0.0% | 0.0% | — | — | — |
| | | FastAR | 0.0% | 0.0% | — | — | — |
| | | CFWoT | 100.0% | 100.0% | 28.889% | 227.184 | 135.1 |
| KNN | 93 | CoMTE | 100.0% | 100.0% | 100.0% | 1284.259 | 1224.0 |
| | | Native-Guide | 100.0% | 100.0% | 55.914% | 63320524766775.734 | 1213.172 |
| | | CFRL | 0.0% | 0.0% | — | — | — |
| | | FastAR | 0.0% | 0.0% | — | — | — |
| | | CFWoT | 6.452% | 100.0% | 50.0% | 588.817 | 496.333 |
| RF | 90 | CoMTE | 100.0% | 100.0% | 100.0% | 1285.888 | 1224.0 |
| | | Native-Guide | 100.0% | 100.0% | 28.889% | 3192621228993.281 | 927.722 |
| | | CFRL | 100.0% | 100.0% | 0.0% | 1277.502 | 1224.0 |
| | | FastAR | 0.0% | 0.0% | — | — | — |
| | | CFWoT | 100.0% | 100.0% | 45.556% | 228.323 | 157.733 |
| RB 1 | 178 | CoMTE | 0.0% | — | — | — | — |
| | | Native-Guide | 66.854% | 66.854% | 17.647% | 134886624123713.94 | 1207.563 |
| | | CFRL | 0.0% | 0.0% | — | — | — |
| | | FastAR | 0.0% | 0.0% | — | — | — |
| | | CFWoT | 96.629% | 100.0% | 86.047% | 188.263 | 144.105 |
| RB 2 | 126 | CoMTE | 100.0% | 100.0% | 100.0% | 1294.181 | 1224.0 |
| | | Native-Guide | 93.651% | 93.651% | 72.881% | 144484808350533.7 | 1208.458 |
| | | CFRL | 0.0% | 0.0% | — | — | — |
| | | FastAR | 0.0% | 0.0% | — | — | — |
| | | CFWoT | 100.0% | 100.0% | 100.0% | 33.756 | 20.587 |

TABLE 6
Quantitative results with Heartbeat dataset

| Predictive | | | Success | Validity | Plausibility | | |
|---|---|---|---|---|---|---|---|
| Model | Nᵢₙᵥ | Methods | Rate | Rate | Rate | Proximity | Sparsity |
| LSTM | 136 | CoMTE | 100.0% | 100.0% | 100.0% | 621.692 | 609.926 |
| | | Native-Guide | 100.0% | 100.0% | 77.206% | 107480237256.711 | 591.346 |
| | | CFRL | 2.941% | 2.941% | 100.0% | 627.946 | 610.0 |
| | | FastAR | 0.0% | 0.0% | — | — | — |
| | | CFWoT | 97.794% | 100.0% | 88.722% | 16.825 | 12.12 |
| KNN | 192 | CoMTE | 100.0% | 100.0% | 100.0% | 626.788 | 609.948 |
| | | Native-Guide | 97.396% | 97.396% | 60.963% | 4748729357720.746 | 600.824 |
| | | CFRL | 0.0% | 0.0% | — | — | — |
| | | FastAR | 0.0% | 0.0% | — | — | — |
| | | CFWoT | 72.396% | 100.0% | 30.935% | 145.611 | 132.288 |
| RF | 147 | CoMTE | 100.0% | 100.0% | 100.0% | 622.636 | 609.864 |
| | | Native-Guide | 65.986% | 65.986% | 79.381% | 1876988887157.566 | 600.68 |
| | | CFRL | 0.0% | 0.0% | — | — | — |
| | | FastAR | 0.0% | 0.0% | — | — | — |
| | | CFWoT | 0.68% | 100.0% | 0.0% | 57.664 | 48.0 |
| RB 1 | 171 | CoMTE | 100.0% | 100.0% | 100.0% | 624.442 | 609.883 |
| | | Native-Guide | 99.415% | 99.415% | 78.235% | 5192329737368.606 | 571.535 |
| | | CFRL | 0.0% | 0.0% | — | — | — |
| | | FastAR | 0.0% | 0.0% | — | — | — |
| | | CFWoT | 70.175% | 100.0% | 43.333% | 173.931 | 162.692 |
| RB 2 | 120 | CoMTE | 100.0% | 100.0% | 100.0% | 619.454 | 609.917 |
| | | Native-Guide | 100.0% | 100.0% | 82.5% | 225633275976.764 | 589.658 |
| | | CFRL | 0.0% | 0.0% | — | — | — |
| | | FastAR | 0.0% | 0.0% | — | — | — |
| | | CFWoT | 100.0% | 100.0% | 90.833% | 13.842 | 9.008 |

TABLE 7
Quantitative results with Racket Sports dataset

| Predictive | | | Success | Validity | Plausibility | | |
|---|---|---|---|---|---|---|---|
| Model | Nᵢₙᵥ | Methods | Rate | Rate | Rate | Proximity | Sparsity |
| LSTM | 78 | CoMTE | 100.0% | 100.0% | 100.0% | 214.707 | 180.0 |
| | | Native-Guide | 100.0% | 100.0% | 75.641% | 202.626 | 161.59 |
| | | CFRL | 0.0% | 0.0% | — | — | — |
| | | FastAR | 14.103% | 14.103% | 100.0% | 1.786 | 1.091 |
| | | CFWoT | 100.0% | 100.0% | 98.718% | 16.734 | 8.295 |
| KNN | 112 | CoMTE | 100.0% | 100.0% | 100.0% | 217.73 | 180.0 |
| | | Native-Guide | 100.0% | 100.0% | 76.786% | 5319556459890.491 | 172.723 |
| | | CFRL | 0.0% | 0.0% | — | — | — |
| | | FastAR | 0.0% | 0.0% | — | — | — |
| | | CFWoT | 100.0% | 100.0% | 66.964% | 54.974 | 29.366 |
| RF | 82 | CoMTE | 100.0% | 100.0% | 100.0% | 214.105 | 180.0 |
| | | Native-Guide | 98.78% | 98.78% | 77.778% | 3528683282737.359 | 167.222 |
| | | CFRL | 0.0% | 0.0% | — | — | — |
| | | FastAR | 0.0% | 0.0% | — | — | — |
| | | CFWoT | 100.0% | 100.0% | 90.244% | 43.695 | 26.232 |
| RB 1 | 111 | CoMTE | 100.0% | 100.0% | 100.0% | 222.762 | 180.0 |
| | | Native-Guide | 94.595% | 94.595% | 67.619% | 116958541727411.39 | 172.486 |
| | | CFRL | 0.0% | 0.0% | — | — | — |
| | | FastAR | 0.0% | 0.0% | — | — | — |
| | | CFWoT | 98.198% | 100.0% | 93.578% | 24.46 | 13.385 |
| RB 2 | 16 | CoMTE | 100.0% | 100.0% | 100.0% | 220.552 | 180.0 |
| | | Native-Guide | 100.0% | 100.0% | 75.0% | 228.065 | 170.125 |
| | | CFRL | 0.0% | 0.0% | — | — | — |
| | | FastAR | 0.0% | 0.0% | — | — | — |
| | | CFWoT | 100.0% | 100.0% | 100.0% | 16.183 | 9.438 |

TABLE 8
Quantitative results with Basic Motions dataset

| Predictive | | | Success | Validity | Plausibility | | |
|---|---|---|---|---|---|---|---|
| Model | Nᵢₙᵥ | Methods | Rate | Rate | Rate | Proximity | Sparsity |
| LSTM | 14 | CoMTE | 100.0% | 100.0% | 100.0% | 782.188 | 600.0 |
| | | Native-Guide | 100.0% | 100.0% | 85.714% | 699.261 | 527.429 |
| | | CFRL | 100.0% | 100.0% | 100.0% | 802.065 | 600.0 |
| | | FastAR | 7.143% | 7.143% | 100.0% | 2.85 | 1.0 |
| | | CFWoT | 100.0% | 100.0% | 100.0% | 87.828 | 38.429 |
| KNN | 19 | CoMTE | 100.0% | 100.0% | 100.0% | 761.556 | 600.0 |
| | | Native-Guide | 100.0% | 100.0% | 78.947% | 706.719 | 562.526 |
| | | CFRL | 100.0% | 100.0% | 100.0% | 795.277 | 600.0 |
| | | FastAR | 0.0% | 0.0% | — | — | — |
| | | CFWoT | 100.0% | 100.0% | 94.737% | 206.984 | 121.421 |
| RF | 20 | CoMTE | 100.0% | 100.0% | 100.0% | 751.741 | 600.0 |
| | | Native-Guide | 100.0% | 100.0% | 80.0% | 721.01 | 574.9 |
| | | CFRL | 100.0% | 100.0% | 100.0% | 773.104 | 600.0 |
| | | FastAR | 0.0% | 0.0% | — | — | — |
| | | CFWoT | 100.0% | 100.0% | 50.0% | 305.677 | 182.25 |
| RB 1 | 35 | CoMTE | 100.0% | 100.0% | 100.0% | 896.874 | 600.0 |
| | | Native-Guide | 97.143% | 97.143% | 88.235% | 804.033 | 584.971 |
| | | CFRL | 0.0% | 0.0% | — | — | — |
| | | FastAR | 0.0% | 0.0% | — | — | — |
| | | CFWoT | 97.143% | 100.0% | 73.529% | 133.66 | 80.559 |
| RB 2 | 8 | CoMTE | 100.0% | 100.0% | 100.0% | 703.79 | 600.0 |
| | | Native-Guide | 100.0% | 100.0% | 75.0% | 687.975 | 562.0 |
| | | CFRL | 0.0% | 0.0% | — | — | — |
| | | FastAR | 0.0% | 0.0% | — | — | — |
| | | CFWoT | 100.0% | 100.0% | 100.0% | 44.01 | 19.25 |

TABLE 9
Prediction model: Random Forest. Nᵢₙᵥ = 15

| Predictive | | | Success | Validity | Plausibility | | |
|---|---|---|---|---|---|---|---|
| Model | Nᵢₙᵥ | Methods | Rate | Rate | Rate | Proximity | Sparsity |
| LSTM | 14 | CoMTE | 100.0% | 100.0% | 100.0% | 346.746 | 260.0 |
| | | Native-Guide | 100.0% | 100.0% | 100.0% | 316.502 | 260.0 |
| | | CFRL | 0.0% | 0.0% | — | — | — |
| | | FastAR | 0.0% | 0.0% | — | — | — |
| | | CFWoT | 100.0% | 100.0% | 100.0% | 54.682 | 31.214 |
| KNN | 16 | CoMTE | 100.0% | 100.0% | 100.0% | 338.141 | 260.0 |
| | | Native-Guide | 100.0% | 100.0% | 93.75% | 1378941378742.368 | 229.938 |
| | | CFRL | 100.0% | 100.0% | 100.0% | 321.046 | 260.0 |
| | | FastAR | 0.0% | 0.0% | — | — | — |
| | | CFWoT | 100.0% | 100.0% | 100.0% | 144.937 | 86.688 |
| RF | 15 | CoMTE | 100.0% | 100.0% | 100.0% | 340.338 | 260.0 |
| | | Native-Guide | 100.0% | 100.0% | 93.333% | 3274652404806.907 | 246.467 |
| | | CFRL | 0.0% | 0.0% | — | — | — |
| | | FastAR | 0.0% | 0.0% | — | — | — |
| | | CFWoT | 100.0% | 100.0% | 100.0% | 68.882 | 46.733 |

In the above, the CFWoT process does not enforce plausibility. CFWoT_{in_dist} enforces plausibility by including F_{in_dist} (x)=True aₜ line 14 which ensures that a CFE is added if and only if it it is in the distribution. A local outlier factor (LOF) may be used as the optional in-oracular distribution detector F_{in-dist}. As can be seen from Tables 10-17 below, CFWoT_{in_dist} achieves plausibility rates of 100%. However, the success rates are lower than those of CFWoT in 22/39 cases. The proximity and sparsity was compared under the same success rates. Although CFWoT_{in_dist} gets hight proximity in 8/17 cases and higher sparsity in 8/17 cases, the changes in the values are small.

TABLE 10
Comparison of CFWoT and CFWoTᵢₙ_{_{—}}_{dist} with NATOPS dataset

| | Success | Validity | Plausibility | | |
|---|---|---|---|---|---|
| Methods | Rate | Rate | Rate | Proximity | Sparsity |
| CFWoT | 100.0% | 100.0% | 28.889% | 227.184 | 135.1 |
| CFWoTᵢₙ_{_{—}}_{dist} | 40.0% | 100.0% | 100.0% | 192.739 | 125.5 |

(a) Prediction model: LSTM. Nᵢₙᵥ = 90.

| | | | | | |
|---|---|---|---|---|---|
| CFWoT | 6.452% | 100.0% | 50.0% | 588.817 | 496.333 |
| CFWoTᵢₙ_{_{—}}_{dist} | 3.226% | 100.0% | 100.0% | 109.59 | 67.0 |

(b) Prediction model: KNN. Nᵢₙᵥ = 93.

| | | | | | |
|---|---|---|---|---|---|
| CFWoT | 100.0% | 100.0% | 45.556% | 228.323 | 157.733 |
| CFWoTᵢₙ_{_{—}}_{dist} | 63.333% | 100.0% | 100.0% | 212.14 | 156.333 |

(c) Prediction model: Random Forest. Nᵢₙᵥ = 90.

| | | | | | |
|---|---|---|---|---|---|
| CFWoT | 96.629% | 100.0% | 86.047% | 188.263 | 144.105 |
| CFWoTᵢₙ_{_{—}}_{dist} | 90.449% | 100.0% | 100.0% | 133.034 | 95.646 |

(d) Prediction model: Rule-Based Model 1. Nᵢₙᵥ = 178.

| | | | | | |
|---|---|---|---|---|---|
| CFWoT | 100.0% | 100.0% | 100.0% | 33.756 | 20.587 |
| CFWoTᵢₙ_{_{—}}_{dist} | 100.0% | 100.0% | 100.0% | 33.756 | 20.587 |

(e) Prediction model: Rule-Based Model 2. Nᵢₙᵥ = 126.

TABLE 11
Comparison of CFWoT and CFWoTᵢₙ_{_{—}}_{dist} with Heartbeat dataset

| | Success | Validity | Plausibility | | |
|---|---|---|---|---|---|
| Methods | Rate | Rate | Rate | Proximity | Sparsity |
| CFWoT | 97.794% | 100.0% | 88.722% | 16.825 | 12.12 |
| CFWoTᵢₙ_{_{—}}_{dist} | 97.794% | 100.0% | 100.0% | 19.104 | 14.714 |

(a) Prediction model: LSTM. Nᵢₙᵥ = 136.

| | | | | | |
|---|---|---|---|---|---|
| CFWoT | 72.396% | 100.0% | 30.935% | 145.611 | 132.288 |
| CFWoTᵢₙ_{_{—}}_{dist} | 25.521% | 100.0% | 100.0% | 87.665 | 77.245 |

(b) Prediction model: KNN. Nᵢₙᵥ = 192.

| | | | | | |
|---|---|---|---|---|---|
| CFWoT | 0.68% | 100.0% | 0.0% | 57.664 | 48.0 |
| CFWoTᵢₙ_{_{—}}_{dist} | 0.0% | — | — | — | — |

(c) Prediction model: Random Forest. Nᵢₙᵥ = 147.

| | | | | | |
|---|---|---|---|---|---|
| CFWoT | 70.175% | 100.0% | 43.333% | 173.931 | 162.692 |
| CFWoTᵢₙ_{_{—}}_{dist} | 30.994% | 100.0% | 100.0% | 83.472 | 75.906 |

(d) Prediction model: Rule-Based Model 1. Nᵢₙᵥ = 171.

| | | | | | |
|---|---|---|---|---|---|
| CFWoT | 100.0% | 100.0% | 90.833% | 13.842 | 9.008 |
| CFWoTᵢₙ_{_{—}}_{dist} | 99.167% | 100.0% | 100.0% | 14.205 | 9.613 |

(e) Prediction model: Rule-Based Model 2. Nᵢₙᵥ = 120.

TABLE 12
Comparison of CFWoT and CFWoTᵢₙ_{_{—}}_{dist}
with Racket Sports dataset

| | Success | Validity | Plausibility | | |
|---|---|---|---|---|---|
| Methods | Rate | Rate | Rate | Proximity | Sparsity |
| CFWoT | 100.0% | 100.0% | 98.718% | 16.734 | 8.295 |
| CFWoTᵢₙ_{_{—}}_{dist} | 100.0% | 100.0% | 100.0% | 16.961 | 8.423 |

(a) Prediction model: LSTM. Nᵢₙᵥ = 78.

| | | | | | |
|---|---|---|---|---|---|
| CFWoT | 100.0% | 100.0% | 66.964% | 54.974 | 29.366 |
| CFWoTᵢₙ_{_{—}}_{dist} | 100.0% | 100.0% | 100.0% | 64.028 | 36.42 |

(b) Prediction model: KNN. Nᵢₙᵥ = 112.

| | | | | | |
|---|---|---|---|---|---|
| CFWoT | 100.0% | 100.0% | 90.244% | 43.695 | 26.232 |
| CFWoTᵢₙ_{_{—}}_{dist} | 100.0% | 100.0% | 100.0% | 44.611 | 27.768 |

(c) Prediction model: Random Forest. Nᵢₙᵥ = 82.

| | | | | | |
|---|---|---|---|---|---|
| CFWoT | 98.198% | 100.0% | 93.578% | 24.46 | 13.385 |
| CFWoTᵢₙ_{_{—}}_{dist} | 98.198% | 100.0% | 100.0% | 25.226 | 13.633 |

(d) Prediction model: Rule-Based Model 1. Nᵢₙᵥ = 111.

| | | | | | |
|---|---|---|---|---|---|
| CFWoT | 100.0% | 100.0% | 100.0% | 16.183 | 9.438 |
| CFWoTᵢₙ_{_{—}}_{dist} | 100.0% | 100.0% | 100.0% | 16.183 | 9.438 |

(e) Prediction model: Rule-Based Model 2. Nᵢₙᵥ = 16.

TABLE 13
Comparison of CFWoT and CFWoTᵢₙ_{_{—}}_{dist}
with Basic Motions dataset

| | Success | Validity | Plausibility | | |
|---|---|---|---|---|---|
| Methods | Rate | Rate | Rate | Proximity | Sparsity |
| CFWoT | 100.0% | 100.0% | 100.0% | 87.828 | 38.429 |
| CFWoTᵢₙ_{_{—}}_{dist} | 100.0% | 100.0% | 100.0% | 87.828 | 38.429 |

(a) Prediction model: LSTM. Nᵢₙᵥ = 14.

| | | | | | |
|---|---|---|---|---|---|
| CFWoT | 100.0% | 100.0% | 94.737% | 206.984 | 121.421 |
| CFWoTᵢₙ_{_{—}}_{dist} | 100.0% | 100.0% | 100.0% | 223.681 | 128.368 |

(b) Prediction model: KNN. Nᵢₙᵥ = 19.

| | | | | | |
|---|---|---|---|---|---|
| CFWoT | 100.0% | 100.0% | 50.0% | 305.677 | 182.25 |
| CFWoTᵢₙ_{_{—}}_{dist} | 95.0% | 100.0% | 100.0% | 321.474 | 199.895 |

(c) Prediction model: Random Forest. Nᵢₙᵥ = 20.

| | | | | | |
|---|---|---|---|---|---|
| CFWoT | 97.143% | 100.0% | 73.529% | 133.66 | 80.559 |
| CFWoTᵢₙ_{_{—}}_{dist} | 97.143% | 100.0% | 100.0% | 157.419 | 104.824 |

(d) Prediction model: Rule-Based Model 1. Nᵢₙᵥ = 35.

| | | | | | |
|---|---|---|---|---|---|
| CFWoT | 100.0% | 100.0% | 100.0% | 44.01 | 19.25 |
| CFWoTᵢₙ_{_{—}}_{dist} | 100.0% | 100.0% | 100.0% | 44.01 | 19.25 |

(e) Prediction model: Rule-Based Model 2. Nᵢₙᵥ = 8.

TABLE 14
Comparison of CFWoT and CFWoTᵢₙ_{_{—}}_{dist} with eRing dataset

| | Success | Validity | Plausibility | | |
|---|---|---|---|---|---|
| Methods | Rate | Rate | Rate | Proximity | Sparsity |
| CFWoT | 100.0% | 100.0% | 100.0% | 54.682 | 31.214 |
| CFWoTᵢₙ_{_{—}}_{dist} | 100.0% | 100.0% | 100.0% | 54.682 | 31.214 |

(a) Prediction model: LSTM. Nᵢₙᵥ = 14.

| | | | | | |
|---|---|---|---|---|---|
| CFWoT | 100.0% | 100.0% | 100.0% | 144.937 | 86.688 |
| CFWoTᵢₙ_{_{—}}_{dist} | 100.0% | 100.0% | 100.0% | 144.937 | 86.688 |

(b) Prediction model: KNN. Nᵢₙᵥ = 16.

| | | | | | |
|---|---|---|---|---|---|
| CFWoT | 100.0% | 100.0% | 100.0% | 68.882 | 46.733 |
| CFWoTᵢₙ_{_{—}}_{dist} | 100.0% | 100.0% | 100.0% | 68.882 | 46.733 |

(c) Prediction model: Random Forest. Nᵢₙᵥ = 15.

| | | | | | |
|---|---|---|---|---|---|
| CFWoT | 100.0% | 100.0% | 100.0% | 103.953 | 63.345 |
| CFWoTᵢₙ_{_{—}}_{dist} | 100.0% | 100.0% | 100.0% | 103.953 | 63.345 |

(d) Prediction model: Rule-Based Model 1. Nᵢₙᵥ = 29.

| | | | | | |
|---|---|---|---|---|---|
| CFWoT | 100.0% | 100.0% | 100.0% | 31.301 | 14.76 |
| CFWoTᵢₙ_{_{—}}_{dist} | 100.0% | 100.0% | 100.0% | 31.301 | 14.76 |

(e) Prediction model: Rule-Based Model 2. Nᵢₙᵥ = 25.

TABLE 15
Comparison of CFWoT and CFWoTᵢₙ_{_{—}}_{dist}
with Japanese Vowels dataset

| | Success | Validity | Plausibility | | |
|---|---|---|---|---|---|
| Methods | Rate | Rate | Rate | Proximity | Sparsity |
| CFWoT | 100.0% | 100.0% | 99.174% | 35.3 | 19.413 |
| CFWoTᵢₙ_{_{—}}_{dist} | 99.174% | 100.0% | 100.0% | 35.753 | 19.833 |

(a) Prediction model: LSTM. Nᵢₙᵥ = 121.

| | | | | | |
|---|---|---|---|---|---|
| CFWoT | 100.0% | 100.0% | 71.774% | 104.147 | 62.073 |
| CFWoTᵢₙ_{_{—}}_{dist} | 94.355% | 100.0% | 100.0% | 114.437 | 74.667 |

(b) Prediction model: KNN. Nᵢₙᵥ = 124.

| | | | | | |
|---|---|---|---|---|---|
| CFWoT | 100.0% | 100.0% | 90.0% | 83.856 | 52.55 |
| CFWoTᵢₙ_{_{—}}_{dist} | 98.333% | 100.0% | 100.0% | 85.103 | 54.314 |

(c) Prediction model: Random Forest. Nᵢₙᵥ = 120.

| | | | | | |
|---|---|---|---|---|---|
| CFWoT | 53.903% | 100.0% | 57.241% | 166.07 | 123.869 |
| CFWoTᵢₙ_{_{—}}_{dist} | 34.201% | 100.0% | 100.0% | 135.475 | 98.674 |

(d) Prediction model: Rule-Based Model 1. Nᵢₙᵥ = 269.

| | | | | | |
|---|---|---|---|---|---|
| CFWoT | 100.0% | 100.0% | 97.987% | 38.206 | 18.436 |
| CFWoTᵢₙ_{_{—}}_{dist} | 99.329% | 100.0% | 100.0% | 38.038 | 18.926 |

(e) Prediction model: Rule-Based Model 2. Nᵢₙᵥ = 149.

TABLE 16
Comparison of CFWoT and CFWoTᵢₙ_{_{—}}_{dist} with Libras dataset

| | Success | Validity | Plausibility | | |
|---|---|---|---|---|---|
| Methods | Rate | Rate | Rate | Proximity | Sparsity |
| CFWoT | 100.0% | 100.0% | 32.584% | 21.421 | 12.73 |
| CFWoTᵢₙ_{_{—}}_{dist} | 93.258% | 100.0% | 100.0% | 39.937 | 23.831 |

(a) Prediction model: LSTM. Nᵢₙᵥ = 89.

| | | | | | |
|---|---|---|---|---|---|
| CFWoT | 100.0% | 100.0% | 14.607% | 45.306 | 24.112 |
| CFWoTᵢₙ_{_{—}}_{dist} | 88.764% | 100.0% | 100.0% | 63.915 | 37.215 |

(b) Prediction model: KNN. Nᵢₙᵥ = 89.

| | | | | | |
|---|---|---|---|---|---|
| CFWoT | 100.0% | 100.0% | 13.095% | 50.151 | 27.024 |
| CFWoTᵢₙ_{_{—}}_{dist} | 88.095% | 100.0% | 100.0% | 61.098 | 40.635 |

(c) Prediction model: Random Forest. Nᵢₙᵥ = 84.

| | | | | | |
|---|---|---|---|---|---|
| CFWoT | 100.0% | 100.0% | 6.034% | 74.67 | 39.647 |
| CFWoTᵢₙ_{_{—}}_{dist} | 50.862% | 100.0% | 100.0% | 87.461 | 50.695 |

(d) Prediction model: Rule-Based Model 1. Nᵢₙᵥ = 116.

| | | | | | |
|---|---|---|---|---|---|
| CFWoT | 100.0% | 100.0% | 20.755% | 45.037 | 23.962 |
| CFWoTᵢₙ_{_{—}}_{dist} | 84.906% | 100.0% | 100.0% | 75.344 | 38.289 |

(e) Prediction model: Rule-Based Model 2. Nᵢₙᵥ = 53.

TABLE 17
Results on adjusting M_{E} and M_{T}

| | | | | | |
|---|---|---|---|---|---|
| Methods | Success Rate | Validity Rate | Plausibility Rate | Proximity | Sparsity |

(a) Dataset: Heartbeat. Prediction model: random forest.

| | | | | | |
|---|---|---|---|---|---|
| CFWoT (M_{E} = 100, M_{T} = 100) | 0.68% | 100.0% | 0.0% | 57.664 | 48.0 |
| CFWoT (M_{E} = 1000, M_{T} = 100) | 10.204% | 100.0% | 20.0% | 267.045 | 253.2 |
| CFWoT (M_{E} = 1000, M_{T} = 1000) | 76.87% | 100.0% | 4.425% | 444.993 | 417.336 |

(b) Dataset: NATOPS. Prediction model: KNN.

| | | | | | |
|---|---|---|---|---|---|
| CFWoT (M_{E} = 100, M_{T} = 100) | 6.452% | 100.0% | 50.0% | 588.817 | 496.333 |
| CFWoT (M_{E} = 1000, M_{T} = 100) | 12.903% | 100.0% | 33.333% | 711.761 | 595.583 |
| CFWoT (M_{E} = 10000, M_{T} = 100) | 26.882% | 100.0% | 16.0% | 782.599 | 627.96 |

As described above, CFWoT, is a model-agnostic reinforcement learning based method that generates counterfactual explanations for static and non-static multivariate time series data. CFWoT operates without requiring a training dataset, is compatible with both classification and regression prediction models, handles continuous and discrete features, and offers functionality such as feature feasibility, feature actionability and causal contrails. CFWoT produces counterfactual explanations with the lowest proximity and sparsity.

It will be appreciated by one of ordinary skill in the art that the system and components shown in FIGS. 1-8 can include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, can be combined together into fewer components or steps or the steps can be performed sequentially, non-sequentially or concurrently. Further, although described above as occurring in a particular order, one of ordinary skill in the art having regard to the current teachings will appreciate that the particular order of certain steps relative to other steps can be changed. Similarly, individual components or steps can be provided by a plurality of components or steps. One of ordinary skill in the art having regard to the current teachings will appreciate that the components and processes described herein can be provided by various combinations of software, firmware and/or hardware, other than the specific implementations described herein as illustrative examples.

While certain features, components, functionality, steps etc. may be described with respect to a particular embodiment, the certain features, components, functionality, steps, etc. may be incorporated into other described embodiments.

The techniques of various embodiments can be implemented using software, hardware and/or a combination of software and hardware. Various embodiments are directed to apparatus, e.g. a node which can be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code can be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor can be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A method for use in explaining a predictive model output comprising:
receiving an initial model input and a target model output;
determining an input adjustment to the initial model input using a trained neural network with parameters θ;
adjusting the model input according to the determined input adjustment;
calculating a reward for the adjusted model input adjustment according to a reward function;
calculating a loss according to a loss function for the trained neural network based on the reward to adjust the parameters θ;
applying the adjusted model input to the trained predictive model;
determining differences between the adjusted model input and the initial model input if the output of the trained predictive model for the adjusted model input matches the target model output; and
outputting the determined difference for use in explaining the predictive model output.

2. The method of claim 1, further comprising:
adjusting the parameters θ of the trained neural network using the calculated loss; and
determining a second input adjustment using the trained neural network with the adjusted parameters θ.

3. The method of claim 1, wherein the initial model input comprises a time series.

4. The method of claim 2, wherein the input adjustment determines a time in the time series to make the adjustment, a feature to adjust and an adjustment to the feature.

5. The method of claim 3, wherein the feature to adjust is a continuous feature.

6. The method of claim 4, wherein the feature is a discrete feature.

7. The method of claim 1, wherein a plurality of subsequent input adjustments are made to the model input.

8. The method of claim 7, wherein the adjusted model input is applied to the trained predictive model after each subsequent input adjustment.

9. The method of claim 8, wherein a plurality of adjusted model inputs are determined, each of which when applied to the trained predictive model generate the target model output.

10. The method of claim 9, wherein one of the plurality of adjusted model inputs is selected as a final adjusted model input.

11. The method of claim 1, wherein the model input is adjusted according to the input adjustment using a state transfer function.

12. The method of claim 1, wherein the reward function determines the reward based on:
the predictive model;
the target output; and
a Distance proximity function that provides a distance between an initial model input and adjusted model input.

13. The method of claim 1, wherein the predictive model is differentiable.

14. The method of claim 1, wherein the predictive model is not differentiable.

15. The method of claim 1, wherein the predictive model is a large language model.

16. The method of claim 1, wherein the input adjustment is made based on user preferences specifying a preference of features to adjust.

17. A non-transitory computer readable medium having instructions stored thereon which when executed by a processor configure a system to perform a method according to claim 1.

18. A system comprising:
a processor capable of executing instructions; and
a memory storing instructions which when executed by the processor configure the system to perform a method according to claim 1.
